(19) United States
(12) Patent Application Publication
(10) Pub. No.: US 2019/0039116 A1
(43) Pub. Date: Feb. 7, 2019

(54) A SEGMENT FOR A CAMSHAFT AND ITS MANUFACTURE

(71) Applicant: OVAKO SWEDEN AB, Hofors (SE)

(72) Inventors: Niklas BENNSTEDT, Toftbyn (SE); Erik CLAESSON, Hofors (SE)

(73) Assignee: OVAKO SWEDEN AB, Hofors (SE)

(21) Appl. No.: 16/074,714

(22) PCT Filed: Feb. 3, 2017
(86) PCT No.: PCT/EP2017/052457

§ 371 Date: Aug. 1, 2018

(30) Foreign Application Priority Data
Feb. 4, 2016 (EP) 16154290.7

(51) Int. Cl. B21D 53/84; F01L 1/047; F16D 1/08; F16H 53/02

(52) U.S. Cl. CPC B21D 53/845; F01L 1/047; F16D 1/0858; F01L 2250/02; F01L 2001/0471; F01L 2101/02; F01L 2103/00; F16H 53/025

(57) ABSTRACT

A segment adapted to be mounted on a shaft to form a camshaft, wherein the segment comprises a through hole adapted to receive the shaft, and wherein the shape of the hole in the segment is adapted to the cross section of the shaft in such a way that when mounted, the segment has a strain causing it to exert a radial load on the shaft in at least two contact points, wherein an inner surface of the hole has at least one deviation to create at least three contact points between the segment and the shaft, and wherein the at least three contact points are non-uniformly distributed about the circumference of the hole. Advantages include that the camshaft can be made lightweight, with less difficulties and at a lower cost as well as with increased precision in angular positioning of the segment on the shaft.

### TECHNICAL FIELD

The present invention relates generally to segments for camshafts as well as a method for their manufacture, more in detail it relates to the fixing of segments such as cam lobes on camshafts.

### BACKGROUND

Generally, camshafts and their manufacture are well known in the art. Two types of camshaft designs dominate the market: solid camshafts and modular camshafts. Of these, solid camshafts generally provide a more durable design for high load applications but are more expensive and time-consuming to manufacture. Modular camshafts are more cost efficient as they provide a lightweight solution and facilitate high volume production. However, the cam lobes and other segments on a modular camshaft have to be fixed with a certain accuracy on the shaft.

EP 0 282 166 discloses a camshaft with an odd number of lobes on the inside of the lobes towards the shaft in contact with the shaft. The numbers in the paragraph refer to the figures in EP 0 282 166. Openings 15 are axially aligned, on a hollow tubular shaft 11 expanded into interference engagement with all of the element openings 15, wherein each of said non-round axial opening 15 has an odd number of regularly spaced lobes 16, said odd number being at least three, the periphery 20 of said opening 15 being primarily defined by joined outwardly-convex arcs 22, 23.

U.S. Pat. No. 5,826,461 discloses cam lobes that are attached by expanding the shaft.

US 2015/0026977 discloses that the cam lobe is shrunk onto the shaft by cooling the shaft and heating the segment.

DE 10 024552 discloses non solid camshaft lobes to be put on a shaft.

US 2010/0088890 discloses camshafts where the attachment is concentric.

DE 15 00 727 discloses fastening of machine parts having a non-round cross section on cylindrical surfaces.

It is still a problem in the art how to simplify the manufacture of camshafts 1 and make lighter and less expensive camshafts.

### SUMMARY

It is an object of the present invention to obviate at least some of the disadvantages in the prior art and provide an improved segment for a camshaft, a camshaft comprising such an improved segment and methods for their manufacture of for camshafts as well as a method for manufacture of a camshaft comprising such an improved segment.

In a first aspect there is provided a segment adapted to be mounted on a shaft to form a camshaft, wherein the segment comprises a through hole adapted to receive the shaft, and wherein the shape of the hole in the segment is adapted to the cross section of the shaft in such a way that when mounted, the segment has a strain causing it to exert a radial load on the shaft in at least two contact points, wherein an inner surface of the hole has at least one deviation to create at least three contact points between the segment and the shaft, wherein the at least three contact points are positioned asymmetrically about the circumference of the hole.

In a second aspect there is provided a camshaft comprising such an improved segment.

In a third aspect there is provided a method for the manufacture of a segment adapted to be mounted on a shaft to form a camshaft, comprising the steps of:
providing a segment;
clamping the segment to deform the segment;
forming a hole in the segment, wherein the shape of the hole is adapted to the cross section of the shaft in such a way that when mounted, the segment has a strain causing it to exert a load on the shaft in at least two contact points;
forming a deviation in an inner surface of the hole to create at least three contact points between the segment and the shaft, wherein the at least three contact points are positioned asymmetrically about the circumference of the hole; and
releasing the radial clamping such that the segment substantially recovers its original shape.

In a fourth aspect there is provided a method for the manufacture of a camshaft comprising at least one segment comprising the steps of:
providing at least one segment according to the first aspect or as manufactured according to the third aspect and a shaft;
clamping the at least one segment radially to deform the at least one segment such that the cross section of the hole in the at least one segment matches the cross section of the shaft;
inserting the shaft axially into the hole in the at least one segment; and
when the at least one segment is placed in the desired position on the shaft, releasing the radial clamping on the at least one segment such that the at least one segment strives to recover its original shape and comes into contact with the shaft in the at least three contact points.

Further aspects and embodiments are defined in the appended claims, which are specifically incorporated herein by reference.

One advantage is that lighter camshafts can be manufactured. Further the manufacturing process becomes easier. Another advantage is that the camshaft is simple and inexpensive to manufacture. Yet another advantage is that a higher precision in positioning and maintaining the position of the segment on the camshaft can be achieved.

A further advantage is that the segment is able to compensate for yielding of the material. If or when the material, in particular at the contact points between the segment and shaft yield with time, the pre-strain in the segment make the segment to act as a spring keeping a radial load on the shaft and thus compensating for the yielding.

### BRIEF DESCRIPTION OF THE DRAWINGS

The invention is now described, by way of example, with reference to the accompanying drawings, in which:

FIG. 1a shows a perspective view of a camshaft assembly according to one aspect of the invention comprising from left to right a cam lobe, a bearing journal, and a gear.

FIG. 1b shows a side view of the camshaft assembly of FIG. 1a.

FIG. 2a shows a front view of the camshaft assembly of FIG. 1a.

FIG. 2b shows a cross sectional view of the camshaft assembly of FIG. 2a cut along the plane A-A.

FIGS. 3a and 3b show a perspective view and a side view respectively of a cam lobe before a hole is made.

FIGS. 4a and 4b show a perspective view and a side view respectively of a cam lobe with a preformed hole.

FIGS. 5a and 5b show a perspective view and a side view respectively of a cam lobe with an oval hole.

FIGS. 6a and 6b show a perspective view and a side view respectively of a cam lobe with a circular hole and one deviation.

FIGS. 7a and 7b show a perspective view and a side view respectively of a cam lobe with an oval hole and one deviation.

FIGS. 8a and 8b show a perspective view and a side view respectively of a cam lobe with and oval hole and one larger and one smaller deviation.

### DETAILED DESCRIPTION

Before the invention is disclosed and described in detail, it is to be understood that this invention is not limited to particular configurations, method steps, substrates, and materials disclosed herein as such configurations, method steps, substrates, and materials may vary somewhat. It is also to be understood that the terminology employed herein is used for the purpose of describing particular embodiments only and is not intended to be limiting since the scope of the present invention is limited only by the appended claims and equivalents thereof.

It must be noted that, as used in this specification and the appended claims, the singular forms “a”, “an” and “the” include plural referents unless the context clearly dictates otherwise.

If nothing else is defined, any terms and scientific terminology used herein are intended to have the meanings commonly understood by those of skill in the art to which this invention pertains.

A deviation denotes a cavity or an indentation on the inner part of the segment. The deviation is a deviation from for instance a circular shape of the hole in the segment.

A segment denotes an object fixed on a shaft to form a camshaft. Examples of segments include but are not limited to a cam lobe 10, a gear 30 and a bearing journal 20.

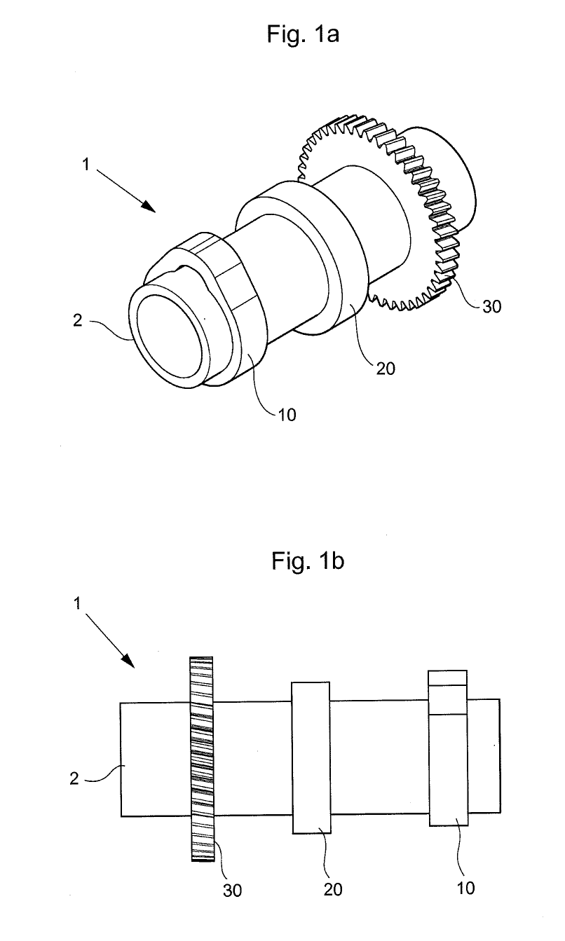

In a first aspect there is provided a segment 10; 20; 30 adapted to be mounted on a shaft 2 to form a camshaft 1 as shown in FIG. 1a. The at least one segment comprises at least one through hole 11 adapted to receive the shaft 2, wherein the shape of the hole 11 in the at least one segment is adapted to the cross section of the shaft 2 in such a way that when mounted, the segment has a strain causing it to exert a load on the shaft 2 in at least two contact points. The load exerted by the segment on the shaft 2 may be seen as a force acting radially inward at the contact points.

The segment is made such that the hole 11 is slightly different from the cross section of the shaft 2 onto which it is intended to be fixed. The hole 11 in the segment does not match the cross section of the shaft 2. In order to position the segment on the shaft 2, the segment is subjected to a clamping such that it deflects or is deformed and the hole 11 changes shape. When the segment is subjected to a radial clamping of suitable magnitude, the hole 11 changes shape such that the hole 11 matches the cross section of the shaft 2 and such that it is possible to insert the shaft 2 in the hole 11 in the segment. This is possible to achieve when designing shape of the segment. The segment may be subjected to a clamping of predetermined magnitude to deform the segment to a predetermined clamping distance in order to obtain the correct shape such that the cross section of the hole 11 matches the cross section of the shaft 2.

The clamping is in one embodiment applied radially to the segment. The clamping is typically applied such that the segment is pressed between two surfaces. In one embodiment the surfaces are adapted to match the shape the outer surface of the segment.

When the clamping is released the segment strives to change its shape back, but since the shape of the hole 11 in the segment and the cross section of the shaft 2 do not match, the segment will exert a radial load on the shaft 2 in at least two contact points. This radial load will hold the segment in the correct position on the shaft 2. The shape of the hole 11 in the segment and the cross section of the shaft 2 only match when a clamping is applied to the segment. Preferably, the clamping should be of a particular magnitude to deform the segment to a predetermined clamping distance. That way, the clamping action and thus deformation of the segment will be reproducible. If no clamping is applied to the segment it strives to revert to its original, equilibrium shape. This equilibrium shape is different and the cross section of the hole 11 does not match the cross section of the shaft 2. It is conceived that the match between the cross section of the shaft 2 and the shape of the hole 11 in the segment, when deformed to the predetermined clamping distance is such that the hole 11 in the segment is slightly larger than the cross section of the shaft 2 such that the segment easily can be put on the shaft 2. This margin can in the light of the description be determined by a skilled person for each application.

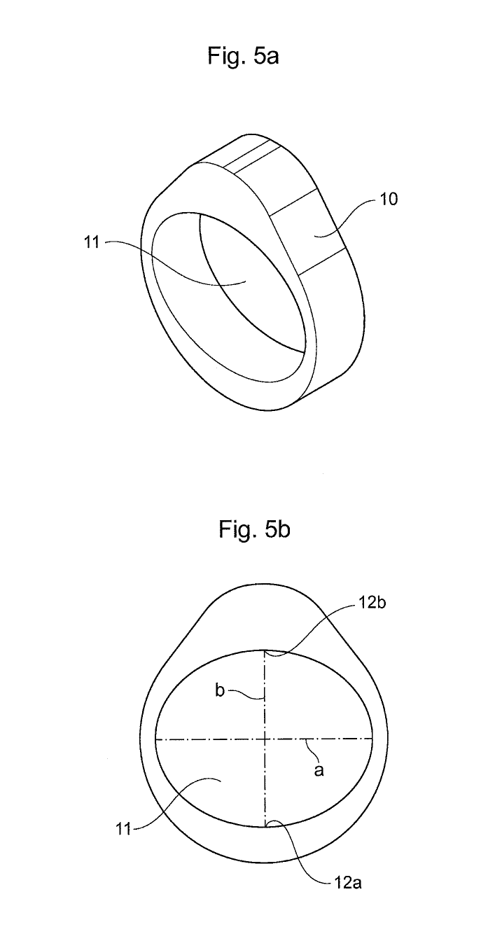

One example is depicted in FIGS. 5a and 5b, where a cam lobe 10 has an oval hole 11 in the shape of an ellipse. The ellipse has a major axis a and a minor axis b. When clamping the cam lobe 10, i.e. by pressing it, the cam lobe 10 will be deformed and the shape of the oval hole 11 will elastically change to a substantially circular hole. Then it is possible to insert a shaft 2 with a circular cross section in the hole 11, while the clamping is still applied. When the clamping is released, the cam lobe 10 has a tendency to return to its original shape with an oval hole 11. Since the cross section of the shaft 2 is circular this creates a strain in the cam lobe 10 such that a radial load is exerted by the cam lobe 10 onto the shaft 2 in two contact points 12a, 12b. The contact points 12a, 12b will be substantially aligned with the minor axis b of the oval hole 11, as this is the smallest distance between diametrically opposed points on the circumference of the oval hole 11. In FIG. 5b the two contact points are located at the uppermost and lowermost points of the oval hole 11.

The cam lobe 10 acts as a spring, with a tendency to return to a shape of the hole 11 in the cam lobe 10 which is different from the cross section of the shaft 2, thereby creating a radial load on the shaft 2. This radial load holds the cam lobe 10 in the correct position.

In one embodiment the radial load exerted by the cam lobe 10 on the shaft 2 in the at least two contact points 12a, 12b is induced by the cam lobe 10 acting as a spring. The cam lobe 10 with load on the shaft 2 can be viewed as a spring clamping onto the shaft 2.

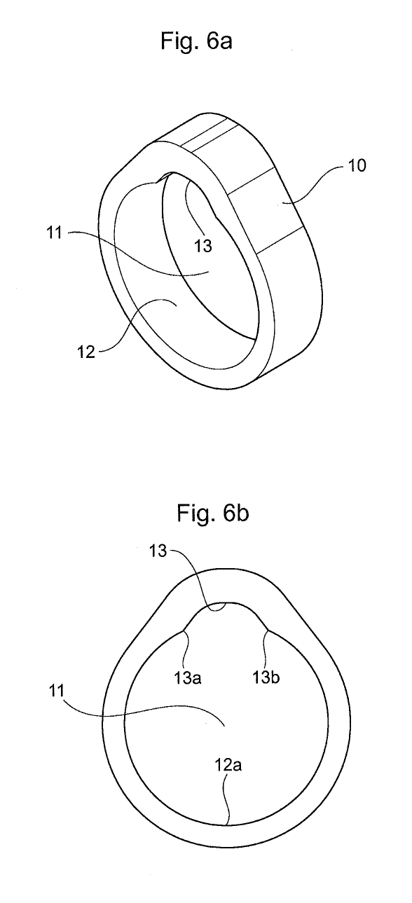

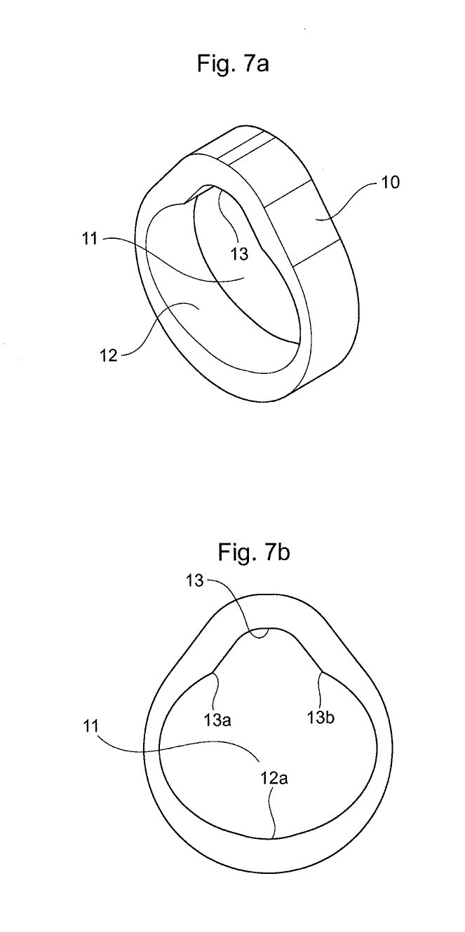

The inventors have found that the radial load to maintain the position of the segment on the shaft 2 is more effective with at least three contact points between the segment and the shaft 2 non-uniformly distributed about the circumference of the hole 11 in the segment; the optimal number of contact points is three. This is achieved by providing a deviation 13 on the inner surface 12 of the segment, i.e. by machining the segment to remove material such that the shape of the hole 11 departs from a circular or oval shape. One embodiment with a deviation 13 in a circular hole 11 is depicted in FIGS. 6a and 6b. Yet another such embodiment with a deviation 13 in an oval hole 11 is depicted in FIGS. 7a and 7b. The deviation 13 creates two edges at the intersections between the circular or oval hole 11 and the deviation 13, which will act as contact points 13a, 13b between the segment and the shaft 2. One advantage with three contact points is that it facilitates the positioning of the segment on the shaft 2. In particular, with three contact points centering of the segment on the shaft 2 is facilitated, that is the precision in angular positioning of the segment about the shaft 2 is increased, which is of high importance for camshafts.

The at least three contact points 12a; 13a, 13b are non-uniformly distributed about the circumference of the hole 11 in the segment. That is, the arc length between adjacent contact points along the circumference of the hole 11 is not equal for all contact points. In one embodiment, the arc length between at least one pair of adjacent contact points is different from the arc lengths between remaining adjacent pairs of contact points. In one embodiment the deviation 13 is substantially aligned with the minor axis b of the oval shape of the hole 11, i.e. opposite one of the two initial contact points 12a, 12b. In this case, the placement of the contact points 12a; 13a, 13b is symmetrical about the minor axis b of the oval hole 11, whereas the arc length between the two contact points 13a, 13b created by the deviation 13 is considerably smaller than the arc length between any of the two contact points 13a, 13b created by the deviation 13 and the opposite initial contact point 12a. Such a placement of the contact points 12a; 13a, 13b will lead to a self-locking effect of the segment on the shaft 2 when a torsional load is applied to the segment at a given point of action. Tests have shown that the radial load exerted by the segment on the shaft 2 at the contact points 12a; 13a, 13b increases with increased applied torque, thus maintaining the position of the segment on the shaft 2. The increased radial load results from the spring clamping effect of the segment striving to return to its original shape in combination with the non-uniform distribution of the contact points 12a; 13a, 13b.

In yet another embodiment there are four contact points, achieved by two deviations 13; 14 in the inner surface 12 of the hole 11 of the segment. Such an embodiment is depicted in FIGS. 6a and 6b, where there is one large deviation 13 creating contact points 13a, 13b and one small deviation 14 creating contact points 14a, 14b. In this embodiment, the deviations 13; 14 are positioned opposite one another and substantially aligned with the minor axis b of the oval hole 11. The size of the deviations 13; 14 determines the arc length about the circumference of the hole 11 between the associated contact points 13a, 13b; 14a, 14b. Thus in one embodiment the number of contact points between the shaft 2 and the at least one segment is from 3 to 4.

According to the invention the segments are made such that the segments exert a load on the shaft 2 holding the segments in place. The deformation (extension or contraction) of the segment is relatively small compared to the overall dimensions of the segments, but the segments can nevertheless be viewed as springs. When mounted on the shaft 2 the deformations of the segments are well below the elastic limit in one embodiment. Compared with a camshaft where the segments are pressed onto the camshaft through plastic deformation, the present invention offers segments acting a springs with a larger interval of possible deformation (extension or contraction) of the segment. This larger movement possibility gives a tolerance forgiving property to the segments and camshaft 1.

In one embodiment at least one of the shaft 2 and the circumference of the hole 11 in the at least one segment comprises grooves. In one embodiment at least one of the shaft 2 and the segment comprises at least one pattern selected from the group consisting of groves, ribs, flutes, serrations, and ridges. At least the part of the segment intended to be in contact with the shaft 2 comprises the pattern. In case additional securing of the segment on the shaft 2 would be necessary some kind of pattern on at least one of the shaft 2 and the circumference of the hole 11 in the segment is present. Examples of such a pattern includes but is not limited to groves, ribs, flutes, serrations, and ridges.

In one embodiment the at least one segment is made from one selected from the group consisting of a tube, a bar, and a forged object. In one embodiment the segments are made from a tube.

In one embodiment, the surfaces of the segment and/or the shaft 2 to be brought into contact are non-uniform before or after mounting of the segment on the shaft 2. This aids in creating distinct contact points to increase the torsional strength.

In one embodiment the segments are made from a tube which has the desired cross section. In one embodiment the tube has near the desired cross section. In one embodiment the cross section of the tube does not deviate more than 2% from the desired cross section of the segment. The tube with the desired cross section is then cut into segments, such as but not limited to cam lobes. The advantage is the ease of manufacture in large scale.

The camshaft 1 may comprise any material suitable for a camshaft. A skilled person can determine which materials are suitable for camshafts with regard to properties including but not limited to temperature resistance, wear resistance, strength and so forth. It is conceived that the shaft 2 and the at least one segment may comprise different materials or the same material. For instance, the shaft 2 is in one embodiment made of a first material, a segment which is a cam lobe 10 is made of a second material, a segment which is a gear 30 is made of a third material, and a segment which is a bearing journal 20 is made of a fourth material. In one embodiment the camshaft 1 comprises at least one composite material. In one embodiment the camshaft 1 comprises at least one composite material comprising a ceramic material and a steel. In one embodiment the camshaft 1 comprises at least one type of steel. In one embodiment the steel is of any grade manufactured with any method. In one embodiment the at least one segment comprises steel. In one embodiment the camshaft 1 comprises at least one engineering steel including but not limited to a through hardening steel, a case hardening steel, a quench and tempering steel and a micro alloyed steel. In one embodiment the camshaft 1 comprises at least one steel found in any one of the standards selected from EN 10083, EN 10084, EN 10085 and ISO 683-17.

In one embodiment the at least one segment is additionally fixed to the shaft 2 using at least one method selected from the group consisting of fixing with a mechanical lock, and fixing with bonding. Bonding includes but is not limited to welding and adhesive bonding. In one embodiment the additional fixing of the segment to the shaft 2 includes at least one selected from the group consisting of welding, brazing, soldering, riveting, and bolting. In one embodiment the at least one segment is additionally fixed to the shaft 2 using at least one method selected from the group consisting of fixing with a mechanical lock, fixing with welding, and fixing using an adhesive. Fixing with a mechanical lock includes but is not limited to fixing with a pin. If an additional securing of the segment would be necessary at least one of these methods can be used. It is also encompassed to use any other method known to a skilled person in order to additionally secure the segment. In many embodiments additional securing is not necessary.

In a third aspect of the invention there is provided a method for the manufacture of a segment adapted to be mounted on a shaft 2 to form a camshaft 1, comprising the steps of:
providing a segment;
clamping the segment to deform the segment;
forming a hole 11 in the segment, wherein the shape of the hole 11 is adapted to the cross section of the shaft 2 in such a way that when mounted, the segment has a strain causing it to exert a load on the shaft 2 in at least two contact points;
forming a deviation 13; 14 in an inner surface 12 of the hole 11 to create at least three contact points between the segment and the shaft 2, wherein the at least three contact points 12a; 13a, 13b; 14a, 14b are non-uniformly distributed about the circumference of the hole 11; and
releasing the clamping such that the segment substantially recovers its original shape.

The segment is manufactured using any suitable method giving the pre-defined shape. The shape of the segment has to be designed to give the correct attachment strain. The design and cross section of the shaft 2 has to be considered when designing the segment. The hole 11 in the segment shall be large enough to allow the shaft 2 to be inserted when a clamping is applied to the segment. When the clamping is released the segment should allow appropriate fixing of the segment on the shaft 2.

In order to achieve reproducible results with high precision when manufacturing segments, the segment is preferably subjected to a controlled clamping to deform the segment to a predetermined dimension. This predetermined dimension is then also used when mounting the segment on the shaft to achieve a substantially identical cross-sectional shape of the hole 11 as when the hole 11 was formed during manufacture.

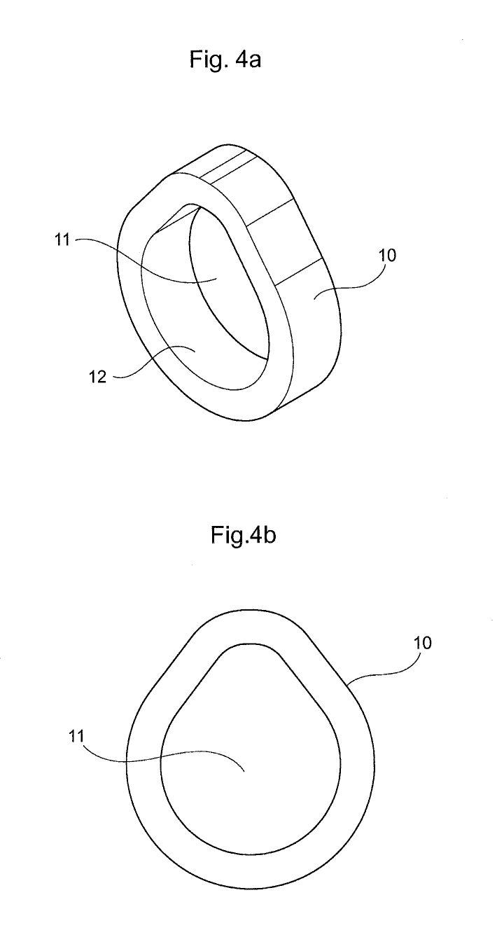

In one embodiment, the segment comprises a preformed hole 11 before the segment is subjected to clamping, as shown in FIGS. 4a and 4b. In this example, the preformed hole 11 follows the contour of the segment, in this case a cam lobe 10.

In one embodiment, the step of forming the deviation 13; 14 may be carried out before the step of forming the hole 11. For example, the deviation 13; 14 may be formed in the segment without any clamping applied. Subsequently, the hole 11 is formed with clamping applied. The deviation 13; 14 does not require applied clamping since the deviation 13; 14 does not need to be adapted to the cross section of the shaft.

In one embodiment the method further comprises the step of hardening the segment.

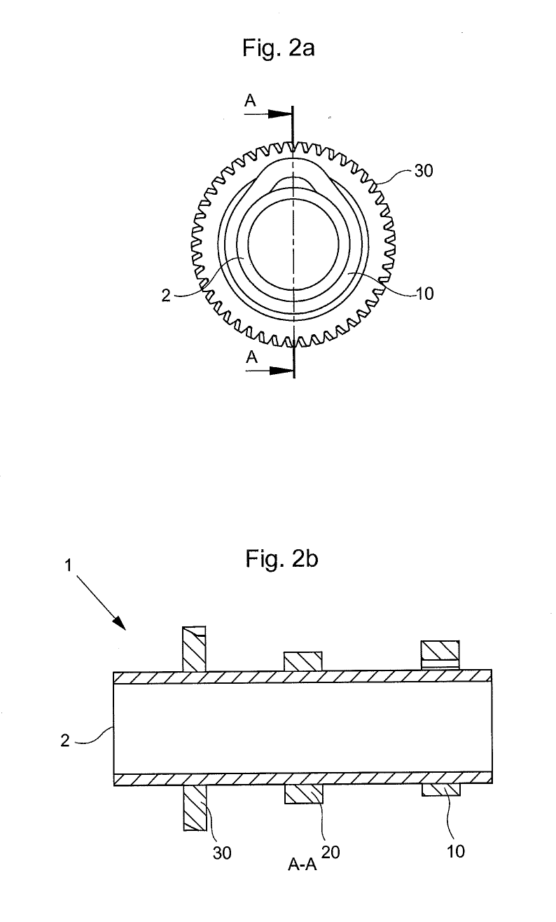

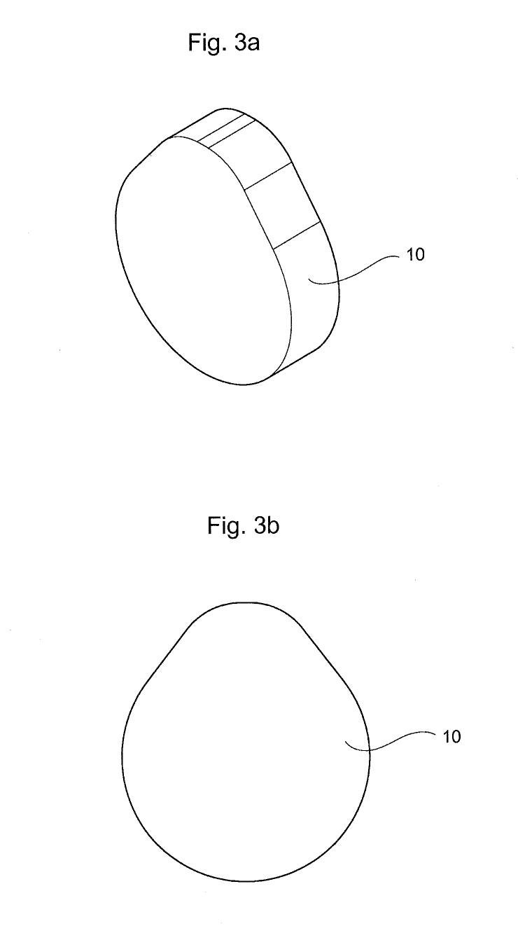

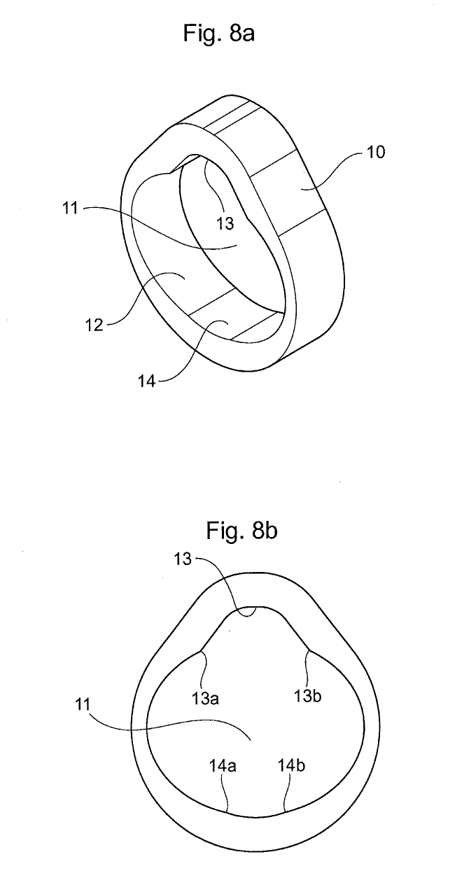

In one embodiment the cross sectional shape of the hole 11 when the clamping is applied is circular. In one embodiment the cross sectional shape of the hole 11 when the clamping is applied is circular with at least one deviation, as shown in FIGS. 6a and 6b. In one embodiment the cross section of the shaft 2 is circular, in such an embodiment the hole 11 is in one embodiment also circular when a clamping is applied to deform the segment to a predetermined dimension. In an alternative embodiment with a circular shaft 2, the hole 11 is partially circular, such that there is at least one deviation, as depicted in FIGS. 1a, 2a, 4a and 4b, 6a and 6b, 7a and 7b, 8a and 8b. The deviation is of any shape as long as material is removed from the segment such that the hole 11 becomes larger and such that the deviation creates a hole 11 which is not entirely circular when clamping is applied. In one embodiment the cross sectional shape of the hole 11 when the clamping is applied is circular with at least one deviation such that the entire circumference of the hole 11 is not circular. I.e. such that the entire circumference of the hole 11 is not a part of a circle, but where more than half of the circumference of the hole 11 is a part of a circle for one deviation. For the case with two deviations or more at least a part of the circumference of the hole 11 is a part of the circular hole 11.

It is conceived that the clamping applied to the segment is adapted to deform the segment to a predetermined dimension, i.e. a specific, predetermined clamping distance. The clamping distance varies depending on the material and shape of the segment.

In one embodiment the hole 11 in the segment is made by clamping the segment radially and thereafter creating the hole 11. In one embodiment there is a preformed hole 11 in the segment and during clamping of the segment the hole 11 is made. In one embodiment a segment with a small hole is clamped, and thereafter a circular hole 11 is drilled in the segment while the clamping is still applied. Preferably, clamping is applied to deform the segment to a predetermined dimension. This will result in a segment with a hole 11 that is non-circular when no clamping is applied and which is circular when a clamping to deform the segment to the predetermined dimension is applied.

In a fourth aspect there is provided a method for the manufacture of a camshaft 1 comprising at least one segment comprising the steps of:
providing at least one segment according to the first aspect or as manufactured according to the second aspect and a shaft 2;
clamping the segment to deform the at least one segment such that the cross section of the hole 11 in the at least one segment matches the cross section of the shaft 2;
inserting the shaft 2 axially into the hole 11 in the at least one segment; and
when the at least one segment is placed in the desired position on the shaft 2, releasing the clamping on the at least one segment such that the at least one segment strives to recover its original shape and comes into contact with the shaft 2 in the at least three contact points.

It is conceived that the clamping may be applied such that the segment is deformed to a predetermined dimension, substantially identical to the dimension of the segment during forming of the hole therein, such that the segment takes the desired shape to fit onto the cross section of the shaft 2.

The segment is positioned in the correct position on the shaft 2 and then the clamping is released such that the segment is fixed in the correct position.

In one embodiment the clamping distance is adapted such that the deformation of the segment is below the yield point such that the material in the segment does not deform plastically, but only deforms elastically when the clamping is applied. In an alternative embodiment the clamping distance is adapted such that the material in the segment deforms plastically when the clamping is applied. In both embodiments it is conceived that the segment at least to some extent shall be able to strive to change its shape such that a load from the segment into the shaft 2 is achieved.

In one embodiment the method further comprises the step of finishing the segment. Examples of finishing includes but are not limited to polishing, grinding, and milling.

In one embodiment the shaft is solid. In an alternative embodiment the shaft 2 is at least partially hollow. In one embodiment the shaft 2 is made from a tube.

In one embodiment the at least one segment is fixed to the camshaft 1 with at least one additional method.

The principle of attaching a segment such as a cam lobe 10 on a camshaft 1 is not only applicable to cam lobes, but also to other segments and objects to be attached to a shaft 2. On a camshaft 1 also other segments can be attached by using the same principle. Examples of such segments include but are not limited to bearing journals 20 and gears 30, as depicted in FIG. 1a.

All the described alternative embodiments above or parts of an embodiment can be freely combined without departing from the inventive idea as long as the combination is not contradictory.

Other features and uses of the invention and their associated advantages will be evident to a person skilled in the art upon reading the description and the examples.

It is to be understood that this invention is not limited to the particular embodiments shown here. The embodiments are provided for illustrative purposes and are not intended to limit the scope of the invention since the scope of the present invention is limited only by the appended claims and equivalents thereof.

1. A segment adapted to be mounted on a shaft to form a camshaft, wherein the segment comprises a through hole adapted to receive the shaft, and wherein the shape of the hole in the segment is adapted to the cross section of the shaft in such a way that when mounted, the segment has a strain causing it to exert a radial load on the shaft in at least two contact points, wherein an inner surface of the hole has at least one deviation to create at least three contact points between the segment and the shaft, and wherein the at least three contact points are non-uniformly distributed about the circumference of the hole.

2. The segment according to claim 1 , wherein two contact points associated with the at least one deviation are positioned substantially opposite a third contact point.

3. The segment according to claim 1, wherein the inner surface of the hole in the segment comprises at least one pattern selected from the group consisting of groves, ribs, flutes, serrations, and ridges.

4. The segment according to claim 1, wherein the at least one segment comprises at least one steel.

5. The segment according to claims claim 1, wherein the segment is made from one selected from the group consisting of a tube, a bar, and a forged object.

6. A camshaft comprising a shaft and at least one segment according to claim 1 mounted on the shaft.

7. The camshaft according to claim 6, wherein the at least one segment is additionally fixed to the shaft using at least one method selected from the group consisting of a mechanical lock, and bonding.

8. The camshaft according to claim 6, wherein the inner surface of the hole in the segment comprises at least one pattern selected from the group consisting of groves, ribs, flutes, serrations, and ridges.

9. A method for the manufacture of a segment adapted to be mounted on a shaft to form a camshaft, comprising the steps:
providing a segment;
clamping the segment to deform the segment;
forming a hole in the segment, wherein the shape of the hole is adapted to the cross section of the shaft in such a way that when mounted, the segment has a strain causing it to exert a load on the shaft in at least two contact points;
forming at least one deviation in an inner surface of the hole to create at least three contact points between the segment and the shaft, wherein the at least three contact points are non-uniformly distributed about the circumference of the hole; and
releasing the clamping such that the segment substantially recovers its original shape.

10. The method according to claim 9, wherein the step of forming the at least one deviation may be carried out before the step of forming the hole.

11. The method according to claim 9, wherein the step of forming the at least one deviation may be carried out before the step of clamping the segment.

12. The method according to claim 9, wherein the segment comprises a preformed hole prior to clamping of the segment.

13. The method according to claim 9, wherein the clamping is applied to deform the segment to a predetermined dimension.

14. The method according to claim 9, wherein the cross sectional shape of the hole during clamping of the segment is circular.

15. The method according to claim 9, wherein the clamping is applied radially.

16. The method according to claim 9, further comprising the step of hardening the at least one segment.

17. A method for the manufacture of a camshaft comprising at least one segment, comprising the steps of:
providing or manufacturing at least one segment according to claim 1;
clamping the segment to deform the at least one segment such that the cross section of the hole in the at least one segment matches the cross section of the shaft;
inserting the shaft axially into the hole in the at least one segment; and
when the at least one segment is placed in the desired position on the shaft, releasing the clamping on the at least one segment such that the at least one segment strives to recover its original shape and comes into contact with the shaft in the at least three contact points.

18. The method according to claim 17, wherein a clamping distance is adapted such that the deformation of the segment is below the yield point such that the material in the segment does not deform plastically, but only deforms elastically when the clamping is applied.

19. The method according to claim 17, wherein a clamping distance is adapted such that the material in the segment deforms plastically when the clamping is applied.

20. The method according to claim 17, wherein the clamping is applied radially.

21. The method according to claim 17, wherein the shaft is solid.

22. The method according to claim 17, wherein the shaft is at least partially hollow.

23. The method according to claim 17, further comprising the step of fixing the at least one segment to the shaft with at least one additional method.

24. The method according to claim 17, further comprising the step of finishing the at least one segment.
